(19) United States
(12) Patent Application Publication
(10) Pub. No.: US 2014/0357329 A1
(43) Pub. Date: Dec. 4, 2014

(54) HOUSING STRUCTURE OF A PORTABLE TELEPHONE DEVICE IN PORTABLE TERMINAL, PORTABLE TERMINAL, AND COMMUNICATION APPARATUS

(71) Applicant: Tetsuya Shimizu, Saitama (JP)

(72) Inventor: Tetsuya Shimizu, Saitama (JP)

(73) Assignee: NEC CASIO MOBILE COMMUNICATIONS, LTD., Kanagawa (JP)

(21) Appl. No.: 14/363,543

(22) PCT Filed: Nov. 19, 2012
(86) PCT No.: PCT/JP2012/079900

§ 371 Date: Jun. 6, 2014

(30) Foreign Application Priority Data
Dec. 16, 2011 (JP) 2011-275597
Jul. 11, 2012 (JP) 2012-155615

(51) Int. Cl. H04M 1/04; H04M 1/21

(52) U.S. Cl. CPC H04M 1/04; H04M 1/21
USPC 455/575.1

(57) ABSTRACT

The object of the present invention provides the housing structure of a portable telephone device in a portable terminal, which enables utilization of the functions of a portable wireless terminal in the integrated state of the portable wireless terminal to the portable terminal. The housing structure houses, in portable terminal 101, the portable wireless terminal that includes first casing 26 and a functional unit configured to perform a predetermined function in an exposed state. Portable terminal 101 includes second casing 110 having a first face and a second face which is adjacent to the first face and in which opening 112 is formed to enable insertion or removal of the portable wireless terminal. Housing unit 111 is formed in second casing 110 to house and fix the portable wireless terminal inserted through opening 112. Opening 112 is continuously formed from the second face to the first face to expose the functional unit in the inserted state of the portable wireless terminal, and the depth of housing unit 111 is equal to the length of first casing 26 or deeper than the length of first casing 26.

### TECHNICAL FIELD

The present invention relates to the housing structure of a portable telephone device in a portable terminal, the portable terminal, and a communication apparatus.

### BACKGROUND ART

Recently, a highly functional portable telephone device referred to as a smartphone and a portable terminal having a large display screen and referred to as a tablet terminal have gained popularity, and there are even some people owning not one but both. Functioning of the smartphone and the tablet terminal as communication apparatuses generally requires SIM (Subscriber Identity Module) cards in which information unique to the user has been recorded. The separate use of the smartphone and the tablet terminal as communication apparatuses requires two SIM cards. In this case, a contract must be made with a communication company to purchase one card for the smartphone and another card for the tablet terminal, which results in increased communication fees. On the other hand, when the smartphone or the tablet terminal is chosen as one communication apparatus, one SIM card must be shared between the smartphone and the tablet terminal. In this case, while the communication fees are reduced, inserting and removing the SIM card, form one device to the other, requires time and effort. Thus, Patent Literature 1 (JP2003-108299A) discloses a method for installing the portable telephone device to the portable terminal to use it integrally with the portable terminal.

### CITATION LIST

Patent Literature 1: JP2003-108299A

### SUMMARY OF INVENTION

### Problems to be Solved by Invention

The portable telephone device and the portable terminal are portable devices, and thus there is the risk possibility that they may fall, while being carried, and be subject to shock. When the portable telephone device falls, while in a state in which it is integrated with the portable terminal, the shock that the portable telephone device receives is greater than the shock of the portable telephone device which is a stand alone because the weight of the portable telephone device increases after being integrated with the portable terminal. It is accordingly desired to employ a housing form in which the entire portable telephone device is enclosed in the portable terminal when the portable telephone device is integrated with the portable terminal to be used. In this housing form, however, the general functions of the portable telephone device, such as a camera, cannot be used. Thus, even the state in which the portable telephone device is integrated with the portable terminal, the portable terminal must be provided with the same functions as those of the portable telephone device. As a result, the component costs of the portable terminal increase, leading to an increase in the unit product price.

The objectives of the present invention are to provide as housing structure of a portable telephone device in a portable terminal, which enables utilization of the functions of a portable wireless terminal, in the state in which the portable wireless terminal is integrated with the portable terminal, the portable terminal, and a communication apparatus.

### Solution to Problem

To achieve the objective, according to the present invention, the housing structure of a portable wireless terminal in a portable terminal is a structure for housing the portable wireless terminal that includes a first casing having a pair of principal faces and a functional unit configured to perform a predetermined function in an exposed state in the portable terminal capable of controlling the portable wireless terminal. The portable terminal includes a second casing having a first face, a second face which is adjacent to the first face and in which an opening is formed to enable insertion or removal of the portable telephone device, and a housing unit formed in the second casing to house and fix the portable wireless terminal inserted through the opening. The opening is formed to be continuously open from the second face to the first face to expose the functional unit in the inserted state of the portable telephone device, and the depth of the housing unit is equal to the length of the first casing or deeper than the length of the first casing.

To achieve the objective, according to the present invention, a portable terminal capable of housing a portable wireless terminal that includes a first casing having a pair of principal faces and a functional unit configured to perform a predetermined function in an exposed state, includes a second casing having a first face, a second face which is adjacent to the first face and in which an opening is formed to enable insertion or removal of the portable wireless terminal, and a housing unit formed in the second casing to house and fix the portable wireless terminal inserted through the opening. The opening is formed to be continuously open from the second face to the first face to expose the functional unit in the inserted state of the portable wireless terminal, and the depth of the housing unit is equal to the length of the first casing or deeper than the length of the first casing.

To achieve the objective, according to the present invention, a communication apparatus includes a portable wireless terminal that includes a first casing having a pair of principal faces and a functional unit configured to perform a predetermined function in an exposed state, and a portable terminal that includes a second casing having a first face, a second face which is adjacent to the first face and in which an opening is formed to enable insertion or removal of the portable wireless terminal, and a housing unit formed in the second casing to house and fix the portable wireless terminal inserted through the opening. The opening is formed to be continuously open from the second face to the first face to expose the functional unit in the inserted state of the portable wireless terminal, and the depth of the housing unit is equal to the length of the first casing or deeper than the length of the first casing.

### Effects of Invention

According to the present invention, the functions of the portable telephone device can be utilized in the state in which the portable telephone device is integrated with the portable terminal, and the shock resistance of the portable telephone device can be secured.

### BRIEF DESCRIPTION OF DRAWINGS

FIG. 1A An upper side view showing a portable telephone device according to the first embodiment of the present invention.

FIG. 1B A front view showing the portable telephone device according to the first embodiment of the present invention.

FIG. 1C A side view showing the portable telephone device according to the first embodiment of the present invention.

FIG. 2A An upper side view showing a portable terminal in which the portable telephone device shown in FIGS. 1A to 1C can be housed.

FIG. 2B A front view showing the portable terminal in which the portable telephone device shown in FIGS. 1A to 1C can be housed.

FIG. 3A An upper side view showing a state where the portable telephone device shown in FIGS. 1A to 1C is integrated with the portable terminal shown in FIGS. 2A and 2B.

FIG. 3B A front view showing a state where the portable telephone device shown in FIGS. 1A to 1C is integrated with the portable terminal shown in FIGS. 2A and 2B.

FIG. 4 An enlarged front view showing the exposed portion of the portable telephone device shown in FIGS. 3A and 3B.

FIG. 5 A block diagram showing the electric configuration of the portable telephone device shown in FIGS. 1A to 1C.

FIG. 6 A block diagram showing the electric configuration of the portable terminal shown in FIGS. 2A and 2B.

FIG. 7 A rear view showing a portable telephone that includes a camera disposed in the rear face of a casing.

FIG. 8 A front view showing a state where the portable telephone device shown in FIG. 7 is integrated with the portable terminal shown in FIGS. 2A and 2B.

FIG. 9A An upper side view illustrating the housing structure of a portable telephone device in a portable terminal according to a second embodiment.

FIG. 9B A front view illustrating the housing structure of the portable telephone device in the portable terminal according to the second embodiment.

FIG. 10A A front view showing a portable telephone device according to a third embodiment.

FIG. 10B A bottom view showing the portable telephone device according to the third embodiment.

FIG. 11A A front view showing a portable terminal to which the portable telephone device shown in FIGS. 10A and 10B is integrated.

FIG. 11B A bottom view showing the portable terminal to which the portable telephone device shown in FIGS. 10A and 10B is integrated.

FIG. 12A An upper side view showing a portable telephone device according to a fourth embodiment.

FIG. 12B A front view showing the portable telephone device according to the fourth embodiment.

FIG. 12C A side view showing the portable telephone device according to the fourth embodiment.

FIG. 12D A bottom view showing the portable telephone device according to the fourth embodiment.

FIG. 13 A front view showing a state where a portable telephone device having a fixture fitted thereto is integrated with a portable terminal.

FIG. 14A A front view illustrating the housing structure of a portable telephone device in a portable terminal according to a fifth embodiment.

FIG. 14B A side view illustrating the housing structure of the portable telephone device in the portable terminal according to the fifth embodiment.

FIG. 15 A side view showing a portable terminal that includes a buffer material in a casing.

FIG. 16A An upper side view illustrating the housing structure of a portable telephone device in a portable terminal according to a sixth embodiment.

FIG. 16B A front view illustrating the housing structure of the portable telephone device in the portable terminal according to the sixth embodiment.

FIG. 16C A side view illustrating the housing structure of the portable telephone device in the portable terminal according to the sixth embodiment.

FIG. 17 A side view showing a fixture shown in FIG. 16A to FIG. 16C.

FIG. 18 A side view showing a portable terminal that includes a buffer material in a casing.

FIG. 19 A front view showing a portable telephone device and a portable terminal according to a seventh embodiment.

FIG. 20A A front view showing a portable terminal according to an eighth embodiment.

FIG. 20B A bottom view showing the portable terminal according to the eighth embodiment.

FIG. 21A A front view showing the portable terminal to which a portable telephone device shown in FIGS. 20A and 20B is integrated.

FIG. 21B A bottom view showing the portable terminal to which the portable telephone device shown in FIGS. 20A and 20B is integrated.

FIG. 22A A flowchart showing a portable telephone device that is housed in a portable terminal in the OFF state of a hands-free mode according to a ninth embodiment.

FIG. 22B A flowchart showing the portable telephone device that is pulled out from the portable terminal in the ON state of the hands-free mode according to the ninth embodiment.

### DESCRIPTION OF EMBODIMENTS

### First Embodiment

The housing structure of a portable telephone device in a portable terminal according to the embodiment of the present invention will be described.

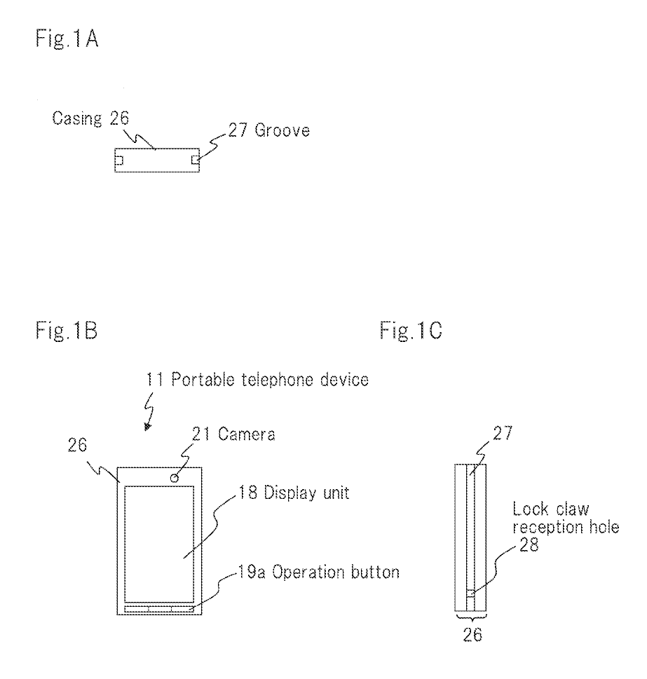

FIG. 1A is an upper side view showing a portable telephone device according to the first embodiment of the present invention. FIG. 1B is a front view showing the portable telephone device according to the first embodiment of the present invention. FIG. 1C is a side view showing the portable telephone device according to the first embodiment of the present invention. In this embodiment, portable telephone device 11 shown in FIGS. 1A to 1C is a smartphone. Portable telephone device 11 includes flat-plate casing 26 (first casing) that has a pair of principal faces that are opposite each other. Display unit 18 is disposed in one of the pair of principal faces (refer to FIG. 1B). Hereinafter, the principal face of casing 26 in which display unit 18 is disposed will be referred to as a front face of casing 26. In the front face of casing 26, camera 21 and operation button 19a are arranged in addition to display unit 18. In both side faces of casing 26 in a longitudinal direction, grooves 27 extending in the longitudinal direction are formed. Lock claw reception hole 28 is formed in the midway of groove 27. Though not shown, an antenna used for communication is installed near an upper side face end.

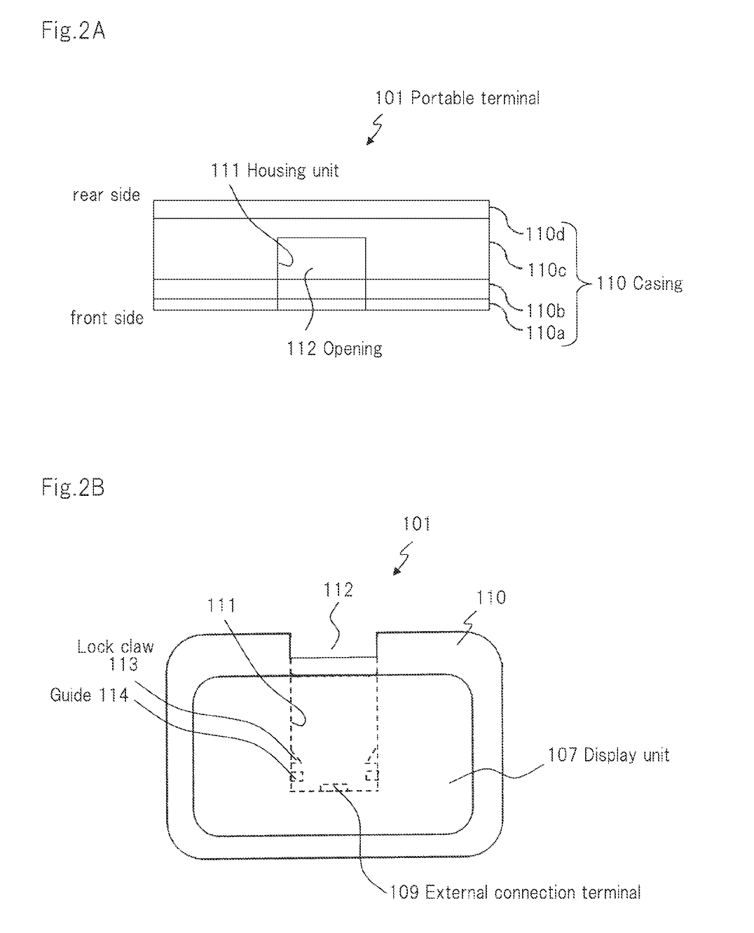

FIG. 2A is an upper side view showing a portable terminal in which portable telephone device 11 shown in FIGS. 1A to 1C can be housed. FIG. 2B is a front view showing the portable terminal in which portable telephone device 11 shown in FIGS. 1A to 1C can be housed. In this embodiment, portable terminal 101 shown in FIGS. 2A and 2B is a tablet terminal. Portable terminal 101 includes flat-plate casing 110 (second casing). Display unit 107 is disposed in one face (first face) of casing 110 (refer to FIG. 2B). Hereinafter, the face of casing 110 in which display unit 107 is disposed will be referred to as a front face of casing 110. Casing 110 includes transparent display unit protection unit 110a that protects display unit 107, display unit housing unit 111b that houses display unit 107, body housing unit 111c that houses the body of portable terminal 101, and rear face exterior unit 110d (refer to FIG. 2A). Display unit protection unit 110a is mainly made of a transparent member such as glass, acrylic or polycarbonate. Display unit housing unit 111b can house a substrate, a switch, or components in addition to display unit 107. A circuit board or the like is housed in body housing unit 111c. Rear face exterior unit 110d is an outer shell of casing 110. Casing 110 can be formed into a structure where rear face exterior unit 110d covers an end or a structure where display unit housing unit 111b and body housing unit 111c are integrated.

Housing unit 111 is formed in body housing unit 111c. Housing unit 111 includes opening 112 that is formed to be continuously open from the front face to the upper side face (second face) of casing 110. In this embodiment, opening 112 is formed into a concave shape when seen from the front face of casing 110. Lock claw 113 and guide 114 are arranged in each of the opposing inner faces of housing unit 111. External connection terminal 109 is disposed in the bottom face of housing unit 111.

In this embodiment, portable terminal 101 is inserted/removed from opening 112 along the longitudinal direction of casing 26 in a state where the front face of casing 26 faces the front face side of casing 110. After portable terminal 101 has been inserted, groove 27 of portable telephone device 11 is engaged with guide 114 of housing unit 111. Then, lock claw 113 of portable terminal 101 is pressed by an elastic member (not shown) to project from the inner face of housing unit 111, and is engaged with lock claw reception hole 28 of portable telephone device 11. Accordingly, portable telephone device 11 is set in an integrated state where it is housed and fixed in housing unit 111 of portable terminal 101. Lock claw 113 is configured movable to be retracted inside housing unit 111 by a lock releasing operation unit (not shown). This movement enables removal of portable telephone device 11 from housing unit 111. This embodiment employs a configuration where groove 27 is formed in portable telephone device 11 and guide 114 is disposed in housing unit 111. However, the embodiment can employ, as an example for mechanistic alignment of the external connection terminal or the lock claw, a configuration where for example, conversely, guide 114 is disposed in portable telephone device 11 and groove 27 is formed in housing unit 111. When the size of the housing unit or the contact portion of the housing unit with portable telephone device 11 is similar to the outer shape of portable telephone device 11, a position of installing is automatically determined, and thus the component such as groove 27 or guide 114 is made unnecessary. When a structure is provided as a guide for guiding the external connection terminal to the casing side of portable telephone device 11 to guide the external connection terminal of portable terminal 101 side to the connection terminal of portable telephone device 11 side, a position of installing is automatically determined, and thus the component such as groove 27 or guide 114 is made unnecessary. Portable telephone device 11 has been described by taking the example of the flat-plate casing that includes the pair of opposing principal faces. However, portable telephone device 11 can have any shape, for example, the curved shape of the rear face or the projected shape of a transmitter/receiver serving as a portable telephone. The other fixing method based on the lock claw is engaging the lock claw which is provided in the external connection terminal 109 with a reception hole which is provide in the external connection terminal of the casing of portable telephone device 11; or a cap shape with respect to housing unit 111 can prevent jumping-out from the housing unit. The external connection terminal can be formed into a cable shape which is preliminarily connected to the portable telephone before housing. In short, the external connection terminal is required to be housed and fixed in housing unit 111 and is required to be connected with an interface. Hereinafter, a integrated state where portable telephone device 11 is housed and fixed in housing unit 111 of portable terminal 101 will be described.

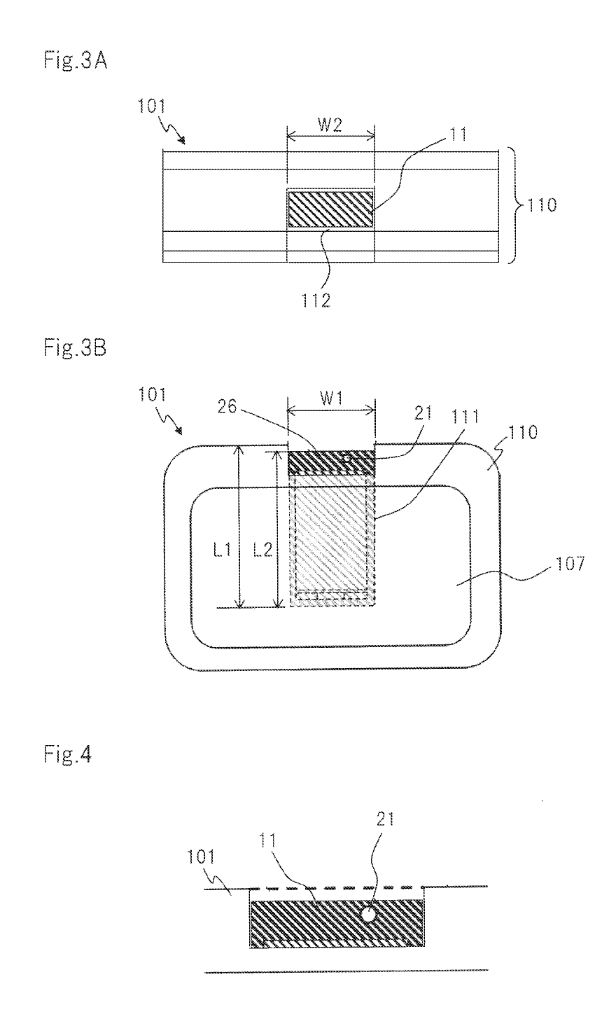

FIG. 3A is an upper side view showing the integrated state according to this embodiment. FIG. 3B is a front view showing the integrated state according to this embodiment. FIG. 4 is an enlarged front view showing the exposed portion of portable telephone device 11. As shown in FIGS. 3B and 4, in the integrated state, camera 21 is exposed from the opening portion (concave portion) of opening 112 formed in the front face of casing 110. Further, in the integrated state, portable telephone device 11 is housed in housing unit 111 not to project out of casing 110 of portable terminal 101. In the integrated state, portable terminal 101 is configured to control camera 21 of portable telephone device 11 and is also configured as a communication apparatus. Hereinafter, the electric configuration of portable telephone device 11 and portable terminal 101 will be described.

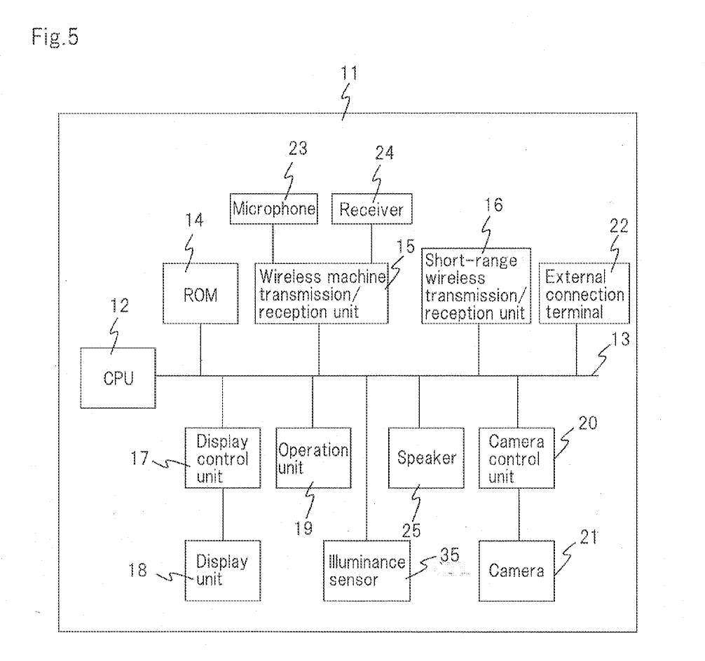

First, the electric configuration of portable telephone device 11 will be described. FIG. 5 is a block diagram showing the electric configuration of the portable terminal shown in FIGS. 1A to 1C. As shown in FIG. 5, portable telephone device 11 includes CPU (Central Processing Unit) 12. CPU 12 is connected to each unit shown in FIG. 5 via bus 13. Hereinafter, each unit connected to CPU 12 will be described. ROM (Read Only Memory) 14 stores fixed data such as a control program executed by CPU 12. Wireless machine transmission/reception unit 15 communicates with a portable telephone line network by radio waves. Microphone 23 and receiver 24 are connected to wireless machine transmission/reception unit 15. Receiver 24 outputs a communication partner's voice. Speaker 25 outputs a preset alarm. Short-range wireless transmission/reception unit 16 performs short-range wireless communication according to the standard of Bluetooth (registered trademark). Display control unit 17 is a control circuit that controls the display operation of display unit 18. Display unit 18 is a liquid crystal display device. Operation unit 19, which is a component for operating portable telephone device 11, includes aforementioned operation button 19a, a touch panel for performing an operation by touching display unit 18, or the like. Camera control unit 20 is a control circuit that controls camera 21. External connection terminal 22 is an interface for connecting to portable terminal 101 via the cable.

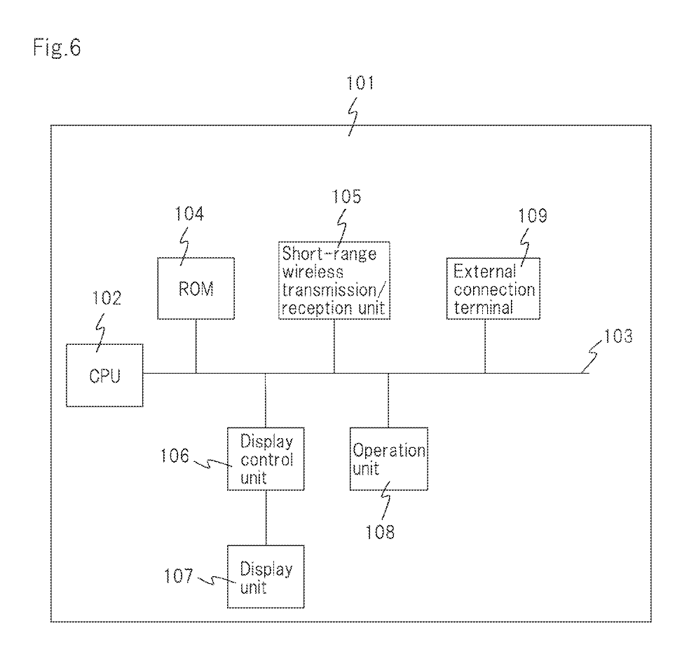

Next, the electric configuration of portable terminal 101 shown in FIGS. 2A and 2B will be described. FIG. 6 is a block diagram showing the electric configuration of the portable terminal shown in FIGS. 2A and 2B. As shown in FIG. 6, portable terminal 101 includes CPU 102. CPU 102 is connected to each unit shown in FIG. 6 via bus 103. Hereinafter, each unit connected to CPU 102 will be described. ROM 104 stores fixed data such as a control program executed by CPU 102. Short-range wireless transmission/reception unit 105 performs, as in the case of short-range wireless transmission/reception unit 16, short-range wireless communication according to the standard of Bluetooth (registered trademark). Display unit 107 is a liquid crystal display device wider in plane area than display unit 18. Display control unit 106 is a control circuit that controls the display operation of display unit 107. Operation unit 108 is a touch panel for performing an operation by touching display unit 107. External connection terminal 109 is a terminal for connection to portable telephone device 11 via the cable. Portable terminal 11 according to this embodiment has no function of communicating with the portable telephone line network by a single terminal.

After portable telephone device 11 has been integrated with portable terminal 101, short-range wireless transmission/reception unit 16 of portable telephone device 11 can perform wireless communication with short-range wireless transmission/reception unit 105 of portable terminal 101. By operating operation unit 108 of portable terminal 101 in this state, portable telephone device 11 can be controlled. Further, according to this embodiment, by operating operation unit 108 of portable terminal 101, image data can be transmitted from external connection terminal 22 of portable telephone device 11 to external connection terminal 109 according to the standard of HDMI (High-Definition Multimedia Interface) to be displayed on display unit 106.

As described above, in this embodiment, after portable telephone device 11 has been housed and fixed in housing unit 111 of portable terminal 101, camera 21 is exposed from opening 112 of housing unit 111. Accordingly, the functions of portable telephone device 11 can be utilized even in the state in which portable telephone device 11 is integrated with portable terminal 101. Further, in this embodiment, depth L1 (refer to FIG. 3B) of housing unit 11 is deeper than length L2 (refer to FIG. 3B) of casing 26 in an insertion/removal direction (longitudinal direction), and accordingly a housing form which prevents portable device 11 from projecting (sticking) out of casing 110 can be employed. Thus, even when portable terminal 11 falls in the housed state of portable telephone device 11, it is difficult for a failure (breakage) to occur in portable telephone device 11 because no direct shock is received. As a result, the shock resistance of portable telephone device 11 can be obtained.

In this embodiment, the longitudinal direction of casing 26 is the insertion/removal direction of portable telephone device 11. However, the short direction of casing 26 can be set as the insertion/removal direction of portable telephone device 11.

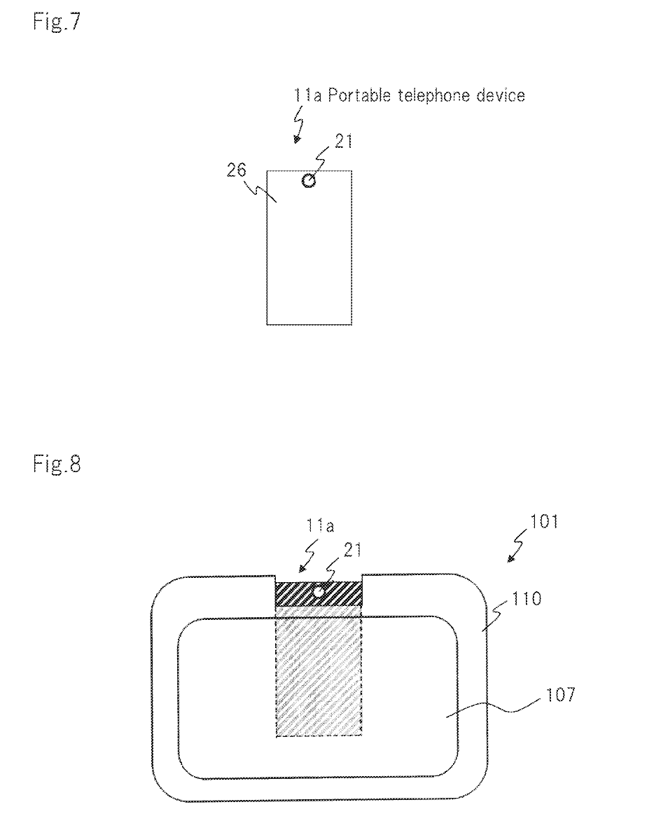

Portable telephone device 11 according to this embodiment is configured such that camera 21 is disposed in the front face of casing 26. However, the present invention is not limited to this configuration. For example, as shown in FIG. 7, the invention can be portable telephone device 11a that includes camera 21 disposed in the rear face (other principal face opposite to one principal face in which display unit 108 is disposed) of casing 26. As shown in FIG. 8, portable telephone device 11a is inserted into housing unit 111 so that camera 21 can be exposed from the concave portion of opening 112.

Portable terminal 101 according to this embodiment is configured such that the concave portion of opening 112 is formed in the front face of casing 110. However, the present invention is not limited to this configuration. For example, the concave portion can be formed in the rear face (principal face opposite the face in which display unit 107 is disposed) of casing 110. Concave portions can be formed in both the front and rear faces of casing 110. In this case, the opening width of the concave portions do not need to be equal or the concave portions do not need to be set at similar positions opposite to each other. When the concave portions of opening 112 are formed in both the front and rear faces of casing 110, portable telephone device 11 can be picked up to be easily removed if each concave portion has an overlapped part about similar in size to a finger.

Portable telephone device 11 according to this embodiment has been described by taking the example of camera 21 as the functional unit utilized in the state in which portable telephone device 11 is integrated with portable terminal 101. However, any functional unit other than camera 21 can be employed, such as receiver 24, speaker 25, display unit 18, illuminance sensor 34, or a touch panel, as long as it can perform a predetermined function in an exposed state. When there is a plurality of functional units, a plurality of concave portions of opening 112 can be formed. When display unit 18 is exposed, for example, by performing a predetermined operation from a power-off state (state where nothing is displayed on display unit 18 or 107), battery icons indicating the residual amount of battery power in portable telephone device 11 and portable terminal 101 are displayed on display unit 18. Accordingly, power consumption can be reduced a greater degree when display data on display unit 107, that has a larger display, than on display unit 18.

In this embodiment, depth L1 of housing unit 111 is deeper than length L2 of the casing in the insertion/removal direction. However, they can be equal. In such a case, while shocks are also applied to portable telephone device 11, portable telephone device 11 receives the shocks at the same time when the casing face of portable terminal 101 receives shocks. Thus, it is only necessary to set weight equivalent to portable telephone device 11 at the upper side area ratio of portable terminal 101 and portable telephone device 11 with respect to the total weight of portable terminal 101 and portable telephone device 11.

### Second Embodiment

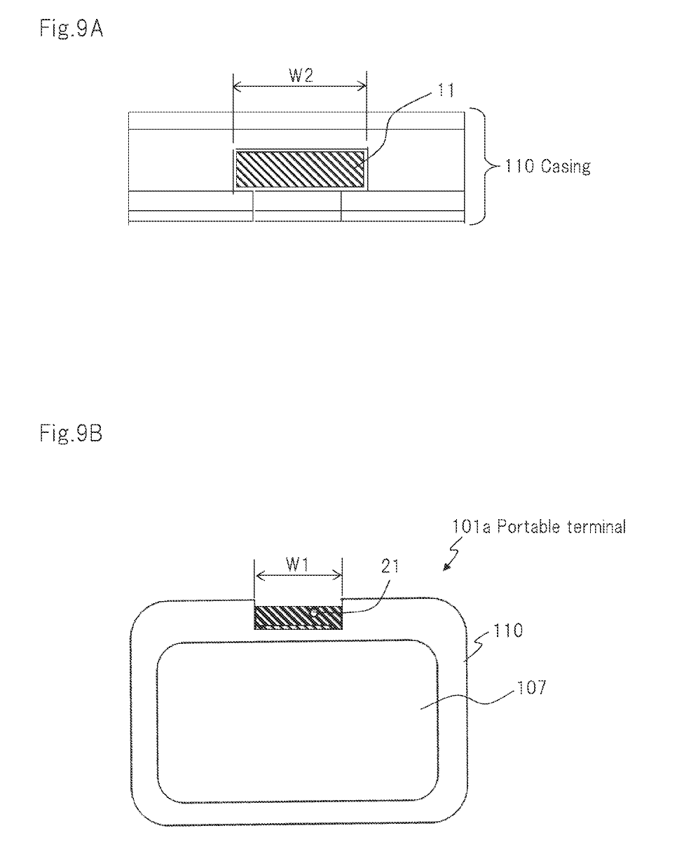

The housing structure of a portable telephone device in a portable terminal according to this embodiment will be described. FIG. 9A is an upper side view illustrating the housing structure according to this embodiment. FIG. 9B is a front view illustrating the housing structure according to this embodiment. Components similar to those of the aforementioned first embodiment will be denoted by similar reference numerals, and detailed description thereof will be omitted.

In portable terminal 101 according to the first embodiment, maximum opening width W1 (refer to FIG. 3B) of the concave portion of opening 112 is equal to maximum opening width W2 (refer to FIG. 3A) of opening 112 in the upper face of casing 110. On the other hand, in portable terminal 101a according to this embodiment, maximum opening width W1 (refer to FIG. 9B) of the concave portion of opening 112 is narrower than maximum opening width W2 (refer to FIG. 9A) of opening 112 in the upper face of casing 110. In other words, in this embodiment, maximum opening width W1 of the concave portion of opening 112 is narrower than that in the first embodiment. Thus, in this embodiment, the resistance of portable telephone device 11 to shock can be obtained with greater certainty because the exposed portion of portable telephone device 11 is reduced more (hidden portion increases) compared with the first embodiment. Corresponding to the narrowed portion, a portion covering portable telephone device 11 is formed. However, deformation may occur depending on the materials of display protection unit 110a and casing 110b and the length of covering, and thus a portion that has weak resistance to external pressure, such as the display unit, is desirably avoided.

### Third Embodiment

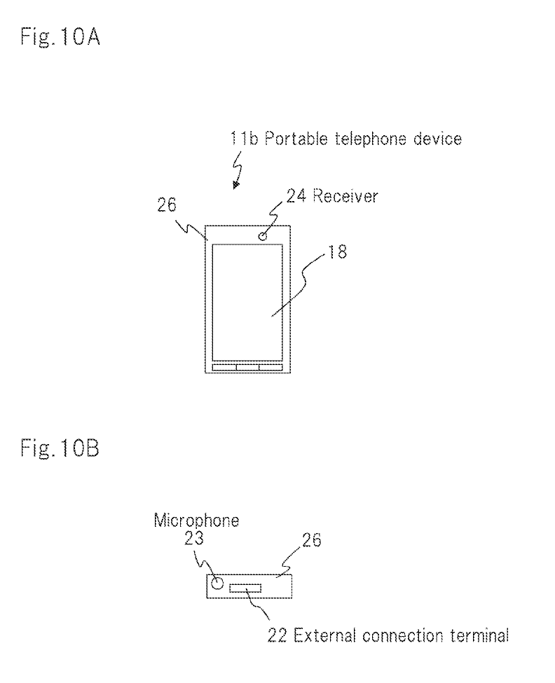

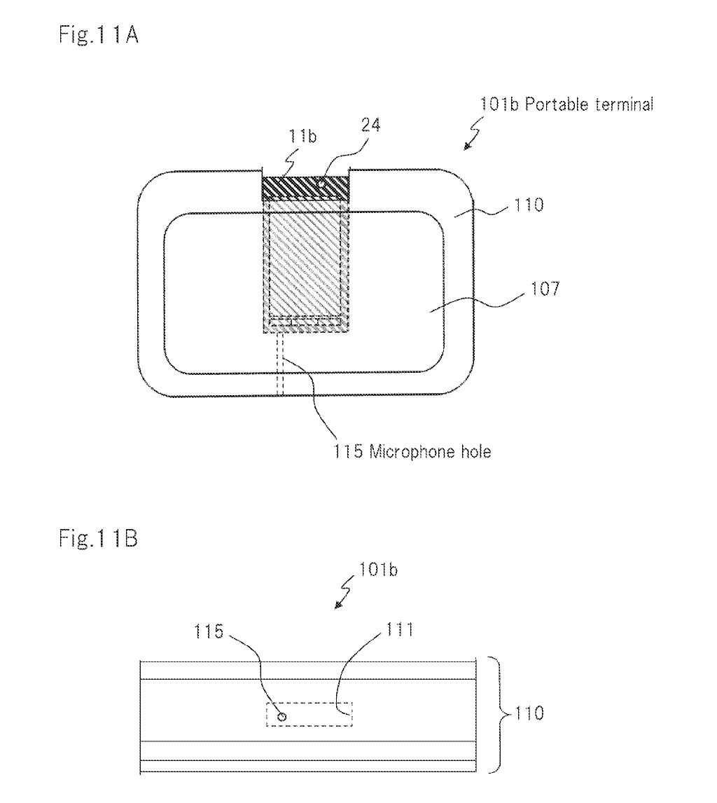

The housing structure of a portable telephone device in a portable terminal according to this embodiment will be described. FIG. 10A is a front view showing the portable terminal according to this embodiment. FIG. 10B is a bottom view showing the portable terminal according to this embodiment. FIG. 11A is a front view showing the portable terminal to which the portable telephone device shown in FIGS. 10A and 10B is integrated. FIG. 11B is a bottom view showing the portable terminal to which the portable telephone device shown in FIGS. 10A and 10B is integrated.

In portable telephone device 11b shown in FIGS. 10A and 10B, receiver 24 is disposed in the front face of casing 26 (refer to FIG. 10A), and microphone 23 and external connection terminal 22 are arranged in the bottom face of casing 26 (refer to FIG. 10B). On the other hand, in portable terminal 101b shown in FIGS. 11A and 11B, microphone hole 115 is formed so that microphone 23 can capture ambient sound. Microphone hole 115 is formed through from the position of housing unit 111 facing microphone 23 to the bottom face of casing 110 (refer to FIGS. 11A and 11B).

According to this embodiment, installing of portable telephone device 11b to portable terminal 101b enables utilization of the function of voice calling.

### Fourth Embodiment

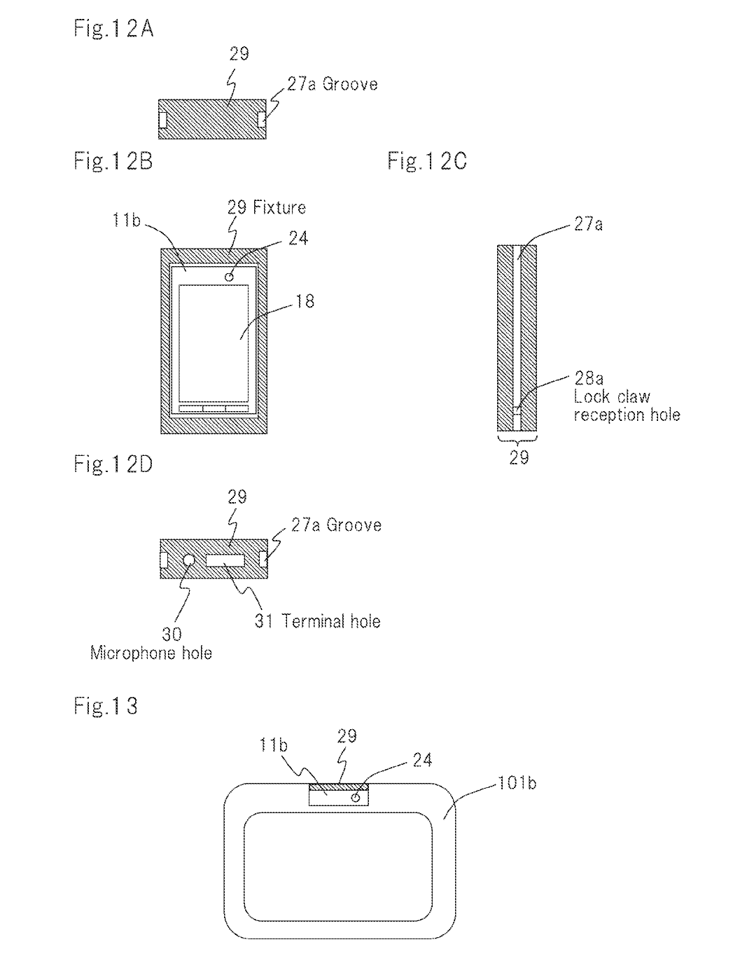

The housing structure of a portable telephone device in a portable terminal according to this embodiment will be described. FIG. 12A is an upper side view showing a portable telephone device according to this embodiment. FIG. 12B is a front view showing the portable telephone device according to this embodiment. FIG. 12C is a side view showing the portable telephone device according to this embodiment. FIG. 12D is a bottom view showing the portable telephone device according to this embodiment. As shown in FIGS. 12A to 12D, in this embodiment, frame-shaped fixture 29 is fitted to portable terminal 11b. FIG. 13 is a front view showing a state where portable telephone device 11b having fixture 29 fitted thereto is integrated with portable terminal 101b.

As shown in FIG. 12C, fixture 29 surrounds portable telephone device 11 to expose the front face of casing 26. As shown in FIGS. 12A and 12C, in fixture 29, groove 27 described above in the first embodiment, groove 27a equivalent to lock claw reception hole 28, and lock claw reception hole 28a are formed. Further, as shown in FIG. 12D, in fixture 29, microphone hole 30 for exposing microphone 23 and terminal hole 31 for exposing external connection terminal 22 are formed.

In this embodiment, portable telephone device 11b is housed in portable terminal 101b in its fitted state to fixture 29. Accordingly, the portable terminal can house even a portable telephone device that has no fixing means described above in the first embodiment, such as groove 27, or such as lock claw reception hole 28, thus increasing general versatility. Even portable telephone devices different in external shape or size can be installed, and thus general versatility is high.

In this embodiment, fixture 29 is configured to surround five faces other than the front face of casing 26. However, fixture 29 can surround minimum necessary faces in order to fix the portable telephone device to the portable terminal, or to cover the full face. For example, an opening for exposing only a functional unit such as a camera can be formed. Further, in fixture 29, an extension circuit can be disposed to connect between external connection terminals.

### Fifth Embodiment

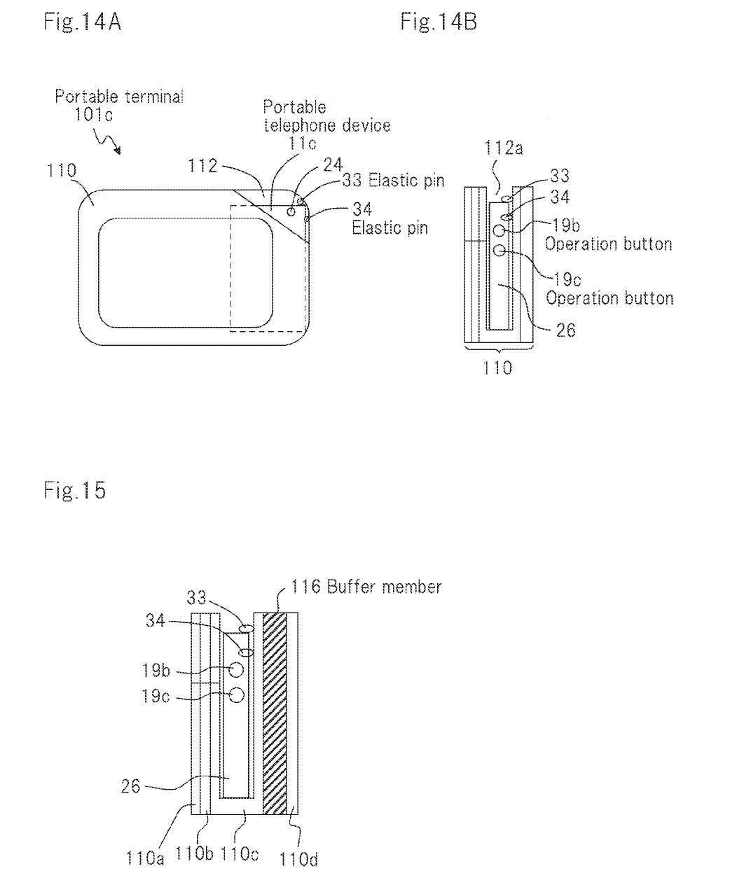

The housing structure of a portable telephone device in a portable terminal according to this embodiment will be described. FIG. 14A is a front view illustrating the housing structure according to this embodiment. FIG. 14B is a side view illustrating the housing structure of the portable telephone device in the portable terminal according to this embodiment.

In portable telephone device 11c shown in FIGS. 14A and 14B, operation buttons 19b and 19c that are parts of operation unit 19 are arranged on the side face (face adjacent to principal face) of casing 26. Operation buttons 19b and 19c function as, for example, volume adjustment buttons, power buttons, buttons for suspending portable telephone device 11c, or buttons to force the shut down of display unit 18.

In portable terminal 101c shown in FIGS. 14A and 14B, opening 112 of housing unit 111 is formed into a notched shape (shape formed by chamfering part of corner) when seen from the front face of casing 110. Opening 112a (other opening) is formed on the right side face (portion facing operation buttons 19b and 19c) of casing 110. This embodiment employs a housing form where the entire right side face of casing 26 is exposed by opening 112a. In this housing form, there is a possibility that portable telephone device 11c will jump out from housing unit 111 not only in the longitudinal direction but also in the short direction of casing 26. Accordingly, elastic pins 33 and 34 are arranged in the inner face of housing unit 111 of portable terminal 101c. Elastic pins 33 and 34 are pressed to project in housing unit 111 of portable terminal 101c by elastic members (not shown). After portable telephone device 11c has been housed in housing unit 111 of portable terminal 101c, elastic pins 33 and 34 project to fix portable telephone device 11c. Specifically, elastic pin 33 regulates movement in the longitudinal direction of casing 26 while elastic pin 34 regulates movement in the short direction of casing 26.

According to this embodiment, by exposing operation buttons 19b and 19c of portable telephone device 11c from housing unit 111 after portable telephone device 11c has been integrated with portable terminal 101c, some functions of portable telephone device 11c can be controlled by operation buttons 19b and 19c. To operate all the functions of portable telephone device 11c at portable terminal 101c after portable telephone device 11c has been integrated with portable terminal 101c, portable terminal 101c needs the operation program of portable telephone device 11c in addition to a single operation program. This causes the control configuration to be complex. However, in this embodiment, the control configuration of portable terminal 101c is simplified by utilizing operation buttons 19b and 19c.

Portable terminal 101c according to this embodiment is structured such that the entire right side face of casing 26 of portable telephone device 11c is can be seen from the housing unit and opening 112a is continuous to opening 112. However, portable terminal 101c can employ a structure where only operation buttons 19b and 19c can be seen while opening 112a is not continuously connected to opening 112, or a structure where opening 112a is covered with a soft material and operation buttons 19b and 19c can be operated via the soft material.

Further, portable terminal 101c according to this embodiment can include, as shown in FIG. 15, flat-plate buffer member 116 at a position near housing unit 111 in casing 110. The inclusion of buffer member 116 enables further mitigation of shocks to portable telephone device 11c. In portable terminal 101c, display unit protection unit 110a disposed in the front side of casing 110 functions as shock mitigation means of portable telephone device 11c. However, no shock mitigation means is installed in the rear side of casing 110. Thus, desirably, buffer member 116 is included between body housing unit 111c and rear face exterior unit 110d. Buffer member 116 can be included in the casing of the portable terminal of each of the aforementioned embodiments.

### Sixth Embodiment

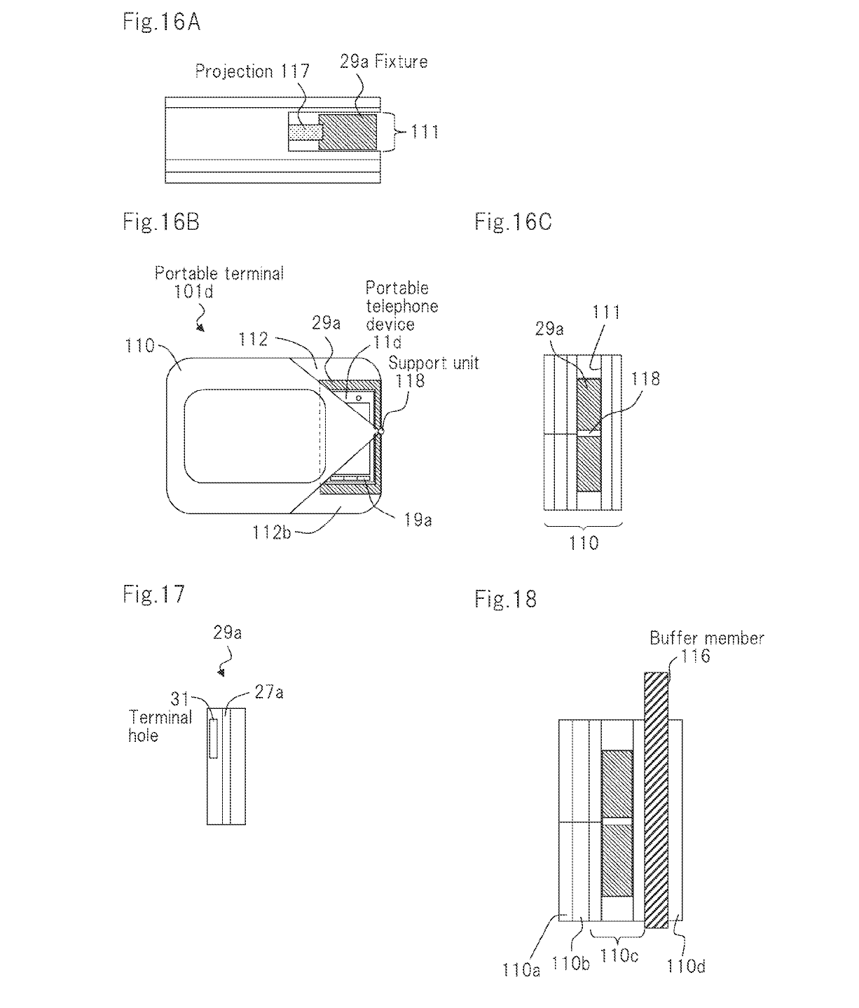

The housing structure of a portable telephone device in a portable terminal according to this embodiment will be described. FIG. 16A is an upper side view illustrating the housing structure according to this embodiment. FIG. 16B is a front view illustrating the housing structure according to this embodiment. FIG. 16C is a side view illustrating the housing structure according to this embodiment.

Operation button 19a that is a part of operation unit 19 is disposed in the front face of portable telephone device 11d shown in FIG. 16B. Operation button 19a has a function similar to those of operation units 19b and 19c described above in the fifth embodiment. Portable telephone device 11d is housed in portable terminal 101d in a state in which it is attached to fixture 29a. On a left side face seen from the front face of fixture 29a, groove 27a and terminal hole 31 are formed as shown in FIG. 17.

In portable terminal 101d according to this embodiment, opening 112b (other opening) is formed to expose operation button 19a in an integrated state. In the inner face of housing unit 111, projection 117 is disposed to be engaged with groove 27a of fixture 29a. Portable terminal 101d is fixed to housing unit 111 through the engagement of projection 117 with groove 27a. Further, the external connection terminals of portable telephone device 11d and portable terminal 101d can be electrically connected to each other through terminal hole 31 of fixture 29a.

Display unit protection unit 110a, display unit housing unit 111b, and support unit 118 that support body housing unit 111c are arranged on the right side face (opening side face) of portable terminal 101d seen from the front face of casing 110. Support unit 118 regulates the movement of portable telephone device 11 in the short direction of casing 26 when portable telephone device 11d is integrated with portable terminal 101d.

According to this embodiment, by exposing operation button 19a of portable telephone device 11d after portable telephone device 11d has been integrated with portable terminal 101d, some functions of portable telephone device 11d can be controlled by operation button 19a. As in the case of the fifth embodiment, the control configuration of portable terminal 101d is simplified by utilizing operation button 19a.

Further, as shown in FIG. 18, portable terminal 101d according to this embodiment can include flat-plate buffer member 116 as in the case of the fifth embodiment. More desirably, a structure where the end of buffer member 116 projects out of casing 110 to mitigate shocks not only to portable telephone device 11d but also to portable terminal 101d is employed.

### Seventh Embodiment

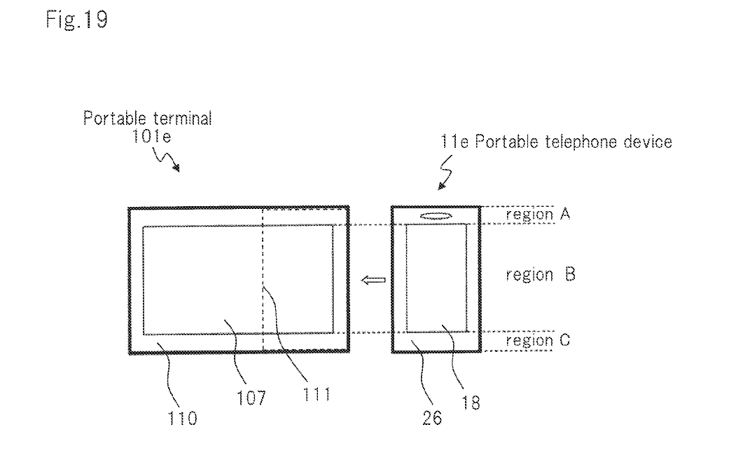

The housing structure of a portable telephone device in a portable terminal according to this embodiment will be described. FIG. 19 is a front view showing the portable telephone device and the portable terminal according to this embodiment. In portable telephone device 11e shown in FIG. 19, the aspect ratio of display unit 18 is 9:16. In portable terminal 101e, the aspect ratio of display unit 107 is 9:16. The length of display unit 107 in a short direction (horizontal direction) is equal to that of display unit 18 in a longitudinal direction (vertical direction). In this embodiment, portable telephone device 11e is inserted along the short direction of casing 26 (display unit 18) into portable terminal 101e.

In portable telephone device 11e, the peripheral regions of display unit 18 in one face of casing 26, i.e., regions A and C where receiver 24, camera 21, and operation button 19a are arranged, have higher resistance to pressure or twisting in the longitudinal direction or the short direction of casing 26 than region B of display unit 18. On the other hand, in portable terminal 101e, because housing unit 111 is formed in casing 110, particularly region B where display unit 107 is disposed is relatively weaker to pressure or twisting than regions B and C that are the peripheral regions of display unit 107. Accordingly, in this embodiment, by housing portable telephone device 11e in housing unit 111 of portable terminal 101e so that the peripheral region of display unit 18 can overlap and abut on the peripheral region of display unit 107, the portable telephone device can be protected from pressure or twisting.

In this embodiment, the appropriate screen size (length of diagonal) of display unit 107 of portable terminal 101e is 16/9 of that of display unit 18 of portable telephone device 11e. Because the screen size of display unit 107 is larger, casing 110 is larger. Then, when microphone hole 115 is formed in casing 110, as in the case of the third embodiment, the length of microphone hole 115 is extended to make sound capturing difficult. Thus, the permitted range of the screen size of portable terminal 101e is about 16/9 of the screen size of portable telephone device 11e+2 inches.

### Eighth Embodiment

The housing structure of a portable telephone device in a portable terminal according to this embodiment will be described. This embodiment is related to a video phone which is related to voice calling of the third embodiment.

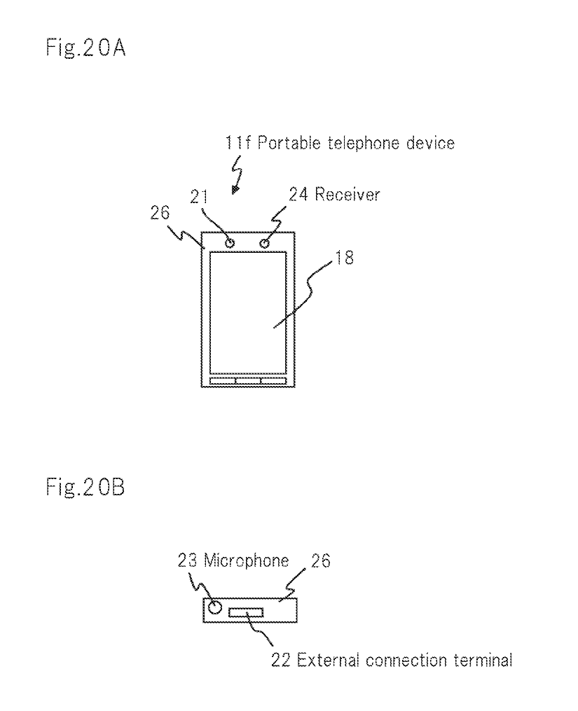

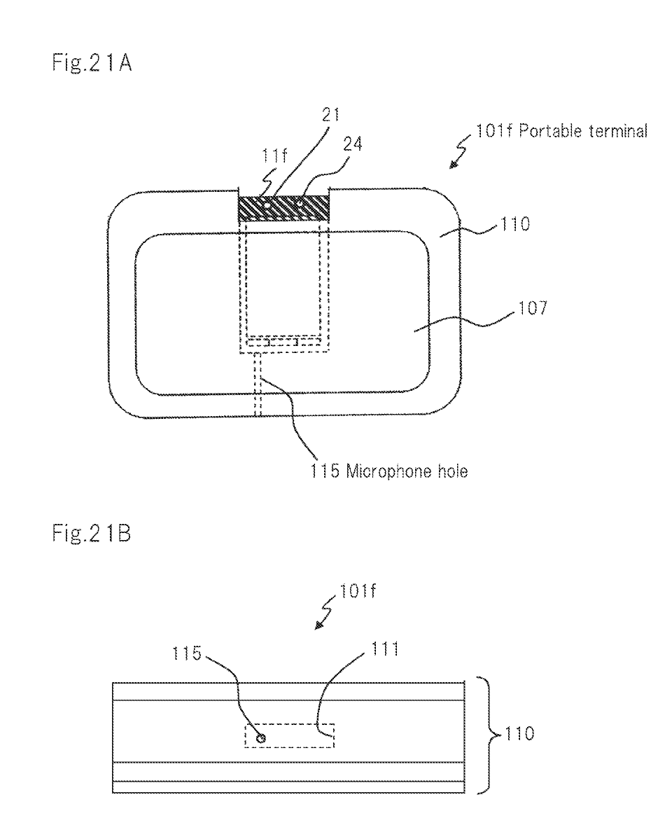

FIG. 20A is a front view showing the portable terminal according to this embodiment. FIG. 20B is a bottom view showing the portable terminal according to this embodiment. FIG. 21A is a front view showing the portable terminal to which the portable telephone device shown in FIGS. 20A and 20B is integrated. FIG. 21B is a bottom view showing the portable terminal to which the portable telephone device shown in FIGS. 20A and 20B is integrated.

In portable telephone device 11f shown in FIGS. 20A and 20B, camera 21 is disposed in the front face of casing 26 different from the case of portable telephone device 11b of the third embodiment (refer to FIG. 20A). As in the case of receiver 24, camera 21 is set at a position to be exposed from the opening after portable telephone device 11f has been integrated with portable terminal 101f. Other components are similar to those of the third embodiment. Portable terminal 101f is similar to those of the other embodiments except for the inclusion of a housing unit that matches the casing shape of portable telephone device 11f.

In this embodiment, as shown in FIG. 21A, camera 21 is can be seen from the opening of portable terminal 101f. This enables problem free use of camera 21 in the vedeo phone for taking photographs.

Microphone 23 can include a plurality of microphones such as a microphone for canceling environmental sound and a microphone for recording sound in the direction at which camera 21 is taking photographs. Such a plurality of microphones can be arranged at different positions, and a plurality of microphone holes 115 can be formed at the positions of the respective microphones.

Microphone hole 115 is desirably formed into a structure and made of a material to be sufficiently large in opening, sufficiently short in length, and acoustically difficult to generate sound. Accordingly, sound can be easily captured by microphone 23, and unnecessary reflection or resonance can be prevented. Desirably, microphone 23 adheres tightly to the housing unit side opening of the portable terminal of microphone hole 115. When necessary, it is desirable to make sound capturing difficult in the housing unit by a shrinkable member such as a sponge or a rubber gasket.

### Ninth Embodiment

In the housed state of portable telephone device 11f in portable terminal 101f (refer to FIG. 21A), telephone calling can be performed by keeping receiver 24 close to the user's ear. However, telephone calling is more difficult in the case of portable telephone device 11f than portable terminal 101f because of its large casing.

Thus, in this embodiment, a hands-free operation in the housed state of the portable telephone device of the eighth embodiment in the portable terminal will be described.

Portable telephone device 11f according to this embodiment includes aforementioned short-range wireless transmission/reception unit 16 (refer to FIG. 5). Thus, when a telephone call is made, speaking and listening can be realized between portable telephone device 11f and an earphone microphone or a headset, as a receiver, by using short-range wireless transmission/reception unit 16.

Portable telephone device 11f according to this embodiment has an operation mode referred to as a hands-free mode that enables calling by bringing receiver 24 close to the ear during a call. In the hands-free mode, a user increases the volume output from receiver 24. When necessary, the user increases input sensitivity from microphone 23, adjusts the directionality of microphone 23 so as not to capture any sound generated from receiver 24, cancels environmental sound, or increases the degree of echo cancellation. The portable telephone device according to this embodiment includes a menu or a shortcut operation for freely switching the hands-free mode ON/OFF.

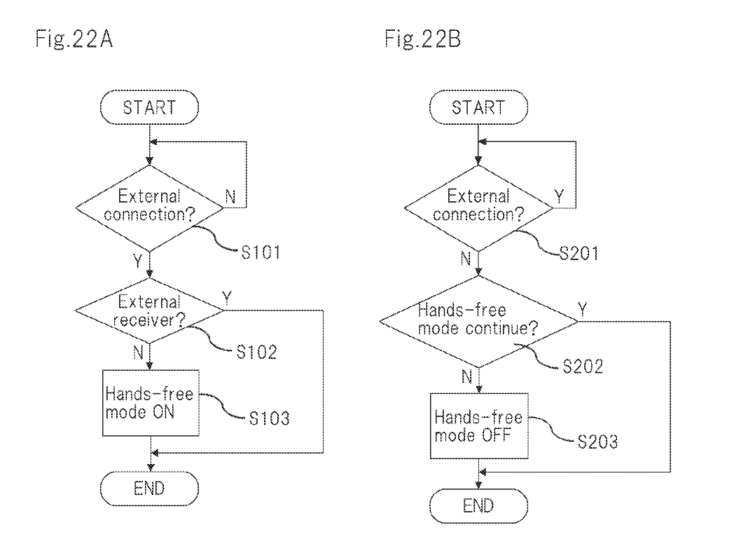

Hereinafter, the operations of the portable telephone device and the portable terminal according to this embodiment will be described by using flowcharts shown in FIGS. 22A and 22B. FIG. 22A is a flowchart when portable telephone device 11f is housed in portable terminal 101f in the OFF state of the hands-free mode according to this embodiment. FIG. 22B is a flowchart when portable telephone device 11f is pulled out from portable terminal 101f in the ON state of the hands-free mode.

First, the operation will be described referring to FIG. 22A. Portable telephone device 11f is in the state of being able to exchange voices with the headset having a microphone or a receiver through short-range wireless transmission/reception unit 16 during calling. Portable telephone device 11f and the headset are wirelessly connected to each other according to the standard of, for example, Bluetooth (registered trademark). Portable telephone device 11f is in the OFF state of the hands-free mode. In step S101, portable telephone device 11f is housed in portable terminal 101f, and CPU 102 checks whether external connection terminal 22 and external connection terminal 109 have been connected to each other. When the connection is confirmed, in step S102, CPU 102 checks whether any external receiver has been connected. When no headset has been connected as an external receiver, for example, when wireless connection has been cut off for one reason or another, when power has been cut off on the headset side, or when there is no remaining battery power, the processing proceeds to step S103. In step S103, portable telephone device 11f changes the hands-free mode to ON to end the processing. When it is determined in step S102 that a headset has been connected as an external receiver, the processing is ended there. When portable telephone device 11f has been in the ON state of the hands-free mode from the start, this processing can be skipped.

Next, the operation will be described referring to FIG. 22B. Portable telephone device 11f is housed in portable terminal 101f, and is in the ON state of the hands-free mode in the interconnected state of external connection terminal 22 and external connection terminal 109. After the user has removed portable telephone device 11f from portable terminal 101f, in step S201, CPU 12 checks whether external connection terminal 22 and external connection terminal 109 have been separated from each other. When the separation is confirmed, in step S202, CPU 12 of portable telephone device 11f causes display unit 18 to indicate whether to continue the hands-free mode, thereby prompting the user to make selection. When the hands-free mode is not continued, in step S203, CPU 12 changes the hands-free mode to OFF. When the hands-free mode is continued, CPU 12 ends the processing there. Step S202, which is not essential, can be skipped. When skipped, the processing can or does not proceed to step S203.

In this embodiment, the processing for switching the hands-free mode ON/OFF has been described. Items indicating an always-ON hands-free mode, an always-OFF hands-free mode, and constant checking of external connection/separation can be displayed on display unit 18, and the operation of the selected item can be preferentially carried out for the aforementioned operation of the flowchart.

Each of the first to seventh embodiments has been described by way of example of the portable telephone device. However, the present invention can be a portable wireless terminal that includes a wireless LAN (Local Area Network). In the eighth and ninth embodiments, any portable terminal can be employed as long as it includes a mode for changing a voice reproduction level from receiver 24.

According to the present invention, the transmission/reception of a command or data based on the HDMI that is an external connection terminal can be performed by a wire interface such as a USB interface (not shown) separately from the HDMI.

The portable terminal of the present invention includes a device such as a display input device responsible only for displaying or an input operation in addition to portable terminals 101 of the aforementioned first to ninth embodiments.

The embodiments of the present invention have been described. However, the present invention is not limited to the embodiments. Various changes understandable to those skilled in the art can be made of the configuration and the specifics of the present invention without departing from the scope of the invention.

This application claims priority from Japanese Patent Application Nos. 2011-275597 filed Dec. 16, 2011, and 2012-155615 filed Jul. 11, 2012, which are hereby incorporated by reference herein in their entirety.

### REFERENCE NUMERALS

11, 11a to 11f Portable telephone device
12, 102 CPU
13, 103 Bus
14, 104 ROM
15 Wireless machine transmission/reception unit
16, 105 Short-range wireless transmission/reception unit
17, 106 Display control unit
18, 107 Display unit
19, 108 Operation unit
19a, 19b, 19c Operation button
20 Camera control unit
21 Camera
22, 109 External connection terminal
23 Microphone
24 Receiver
25 Speaker
26, 110 Casing
27, 27a Groove
28, 28a Lock claw reception hole
29, 29a Fixture
30 Microphone hole
31 Terminal hole
32, 33 Elastic pin
34 Illuminance sensor
101, 101a to 101f Portable terminal
111 Housing unit
112, 112a, 112b Opening
113 Lock claw
114 Guide
115 Microphone hole
116 Buffer member
117 Projection
118 Support unit

1. A housing structure of a portable wireless terminal that includes a first casing having a pair of principal faces and a functional unit configured to perform a predetermined function in an exposed state in a portable terminal capable of controlling the portable wireless terminal, wherein:
the portable terminal includes a second casing having a first face, a second face which is adjacent to the first face and in which an opening is formed to enable insertion or removal of the portable wireless terminal, and a housing unit formed to house and fix the portable wireless terminal inserted through the opening;
the opening is formed to be continuously open from the second face to the first face to expose the functional unit in the inserted state of the portable wireless terminal; and
a depth of the housing unit is equal to a length of the first casing or deeper than the length of the first casing.

2. The housing structure of the portable wireless terminal in the portable terminal according to claim 1, wherein the opening is formed into a concave shape when seen from the first face, and a maximum opening width on the first face is narrower than that on the second face.

3. The housing structure of the portable wireless terminal in the portable terminal according to claim 1, wherein:
the portable wireless terminal further includes an operation button disposed on a side face adjacent to the principal face and configured to operate the functional unit; and
the portable terminal includes another opening formed at a position of the second casing opposite the operation button to expose the operation button in the inserted state of the portable wireless terminal.

4. The housing structure of the portable wireless terminal in the portable terminal according to claim 1, wherein the portable wireless terminal is housed in the housing unit in a state of being fitted to a frame-shaped fixture that surrounds the first casing and includes fixing means formed to fix the portable wireless terminal in the housing unit.

5. The housing structure of the portable wireless terminal in the portable terminal according to claim 1, wherein:
the portable wireless terminal further includes a receiver as the functional unit on one of the principal faces and a microphone on a side face adjacent to one of the principal faces but not exposed from the opening; and
the portable terminal further includes a microphone hole formed on a position of the housing unit opposite the microphone through the second casing.

6. The housing structure of the portable wireless terminal in the portable terminal according to claim 1, wherein the portable terminal further includes a buffer member disposed at a position near the housing unit in the second casing.

7. The housing structure of the portable wireless terminal in the portable terminal according to claim 6, wherein an end of the buffer member projects out of the second casing.

8. The housing structure of the portable wireless terminal iii the portable terminal according to claim 1, wherein the portable wireless terminal is housed in the portable terminal so that a peripheral region of a display unit formed in one of the principal faces of the first casing can overlap and abut on a peripheral region of a display unit formed in the first face of the second casing.

9. A portable terminal capable of housing a portable wireless terminal that includes a first casing having a pair of principal faces and a functional unit configured to perform a predetermined function in an exposed state, comprising:
a second casing having a first face, a second face which is adjacent to the first face and in which an opening is formed to enable insertion or removal of the portable wireless terminal, and a housing unit formed to house and fix the portable wireless terminal inserted through the opening, wherein:
the opening is formed to be continuously open from the second face to the first face to expose the functional unit in the inserted state of the portable wireless terminal; and
a depth of the housing unit is equal to a length of the first casing or deeper than the length of the first casing.

10. A communication apparatus comprising:
a portable wireless terminal that includes a first casing having a pair of principal faces and a functional unit configured to perform a predetermined function in an exposed state; and
a portable terminal that includes a second casing having a first face, a second face which is adjacent to the first face and in which an opening is formed to enable insertion or of the portable wireless terminal, and a housing unit formed to house and fix the portable wireless terminal inserted through the opening, wherein:
the opening is formed to be continuously open from the second face to the first face to expose the functional unit in the inserted state of the portable wireless terminal; and
a depth of the housing unit is equal to a length of the first casing or deeper than the length of the first casing.
